(19) United States
(12) Patent Application Publication
(10) Pub. No.: US 2016/0077565 A1
(43) Pub. Date: Mar. 17, 2016

(54) FREQUENCY CONFIGURATION OF ASYNCHRONOUS TIMING DOMAINS UNDER POWER CONSTRAINTS

(71) Applicant: ADVANCED MICRO DEVICES, INC., Sunnyvale, CA (US)

(72) Inventor: Ramkumar Jayaseelan, Austin, TX (US)

(21) Appl. No.: 14/489,138

(22) Filed: Sep. 17, 2014

(51) Int. Cl. G06F 1/28; G06F 9/54

(52) U.S. Cl. CPC G06F 1/28; G06F 9/546

(57) ABSTRACT

A processing device includes one or more queues to convey data between a producing processor unit in a first timing domain and a consuming processor unit in a second timing domain that is asynchronous with the first timing domain. A system management unit configures a first operating frequency of the producing processor unit and a second operating frequency of the consuming processor unit based on a power constraint for the processing device and a target size of the one or more queues.

### CROSS REFERENCE TO RELATED APPLICATIONS

This application is related to U.S. patent application Ser. No. ______ (Attorney Docket No. 1458-130067), entitled “POWER AND PERFORMANCE MANAGEMENT OF ASYNCHRONOUS TIMING DOMAINS IN A PROCESSING DEVICE” and filed on even date herewith, the entirety of which is incorporated by reference herein.

### BACKGROUND

1. Field of the Disclosure

The present disclosure relates generally to processing devices and, more particularly, to asynchronous timing domains in processing devices.

2. Description of the Related Art

Components in conventional processing devices have traditionally been synchronized to a single global clock. For example, the same global clock signal may be provided to a central processing unit (CPU), a graphics processing unit (GPU), an accelerated processing unit (APU), or other entities in the processing device. Motivated in part by a demand for more efficient use of power, processing devices are being designed with multiple timing domains that synchronize to different clock frequencies. For example, a different voltage may be supplied to each processor core in a CPU and the supply voltages may be varied independently for the different processor cores. Consequently, the operating frequencies of the processor cores may differ and may vary independently of each other so that each processor core is part of a different, asynchronous, timing domain. For another example, the CPUs, the GPUs, or the APUs in a processing device may be implemented in different timing domains.

Components in asynchronous timing domains may produce or consume data at different rates because they operate at different voltages and frequencies and also the complexity of the tasks assigned to them is different. Thus, a producing component may generate data faster or slower than a consuming component can process, or “consume,” the data generated by the producing component. Queues may therefore be used to buffer data that is being transmitted between a producing component and a consuming component in asynchronous timing domains. For example, a queue may be implemented between a CPU and a GPU to buffer commands from the CPU that describe the surfaces or objects that are subsequently rendered by the GPU.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device according to some embodiments.

FIG. 2 is a block diagram of a processing device according to some embodiments.

FIG. 3 is a flow diagram of a method of configuring a CPU clock frequency and a GPU clock frequency according to some embodiments.

FIG. 4 is a plot that depicts combinations of the CPU clock frequency and the GPU clock frequency according to some embodiments.

FIG. 5 is a block diagram of a fuzzy controller according to some embodiments.

FIG. 6 is a flow diagram illustrating a method for designing and fabricating an integrated circuit device implementing at least a portion of a component of a processing system according to some embodiments.

### DETAILED DESCRIPTION

Power constraints such as Thermal Design Power (TDP) limits or battery power limits may not permit all the processing units in a processing device to operate at maximum frequency. For example, the power dissipation rate increases cubically with frequency and operating both a CPU and a GPU at their maximum frequencies typically exceeds the TDP. The overall performance of the processing device therefore depends upon the allocation of power to the CPU and GPU because the power allocation affects the processing speed of the CPU and the GPU. For example, the queue may become empty when the GPU consumes information from the queue faster than the CPU provides the information. When the queue is frequently empty the GPU is not operated at maximum throughput. Conversely, the queue may fill when the CPU is producing information for the queue than the GPU consumes the information. When the queue fills up the CPU is using frequency (power) the GPU could have used.

The performance of a processing device during exchange of information between components in asynchronous timing domains may be optimized by selecting clock frequencies for the timing domains based on a power constraint for the processing device and a target occupancy of a queue that conveys information between the components in the asynchronous timing domains. In some embodiments, the clock frequencies are determined by comparing a rate at which packets arrive in the queue from a producer processing unit in one timing domain and the time required for a consumer processing unit in another timing domain to process a packet from the queue. The expected occupancy of the queue is equal to the product of the CPU packet production rate and the time interval it takes a GPU to process a packet from the queue. Some embodiments may use an iterative process to choose combinations of the CPU clock frequency and the GPU clock frequency so that the expected occupancy is within a predetermined tolerance of the target occupancy and the predicted power consumption of the CPU and GPU is less than the power constraint for the processing device. Some embodiments may use a fuzzy controller to control the CPU and GPU clock frequencies based on periodically or continuously monitored values of parameters such as a packet arrival rate in the queue, a packet complexity, or a current queue occupancy.

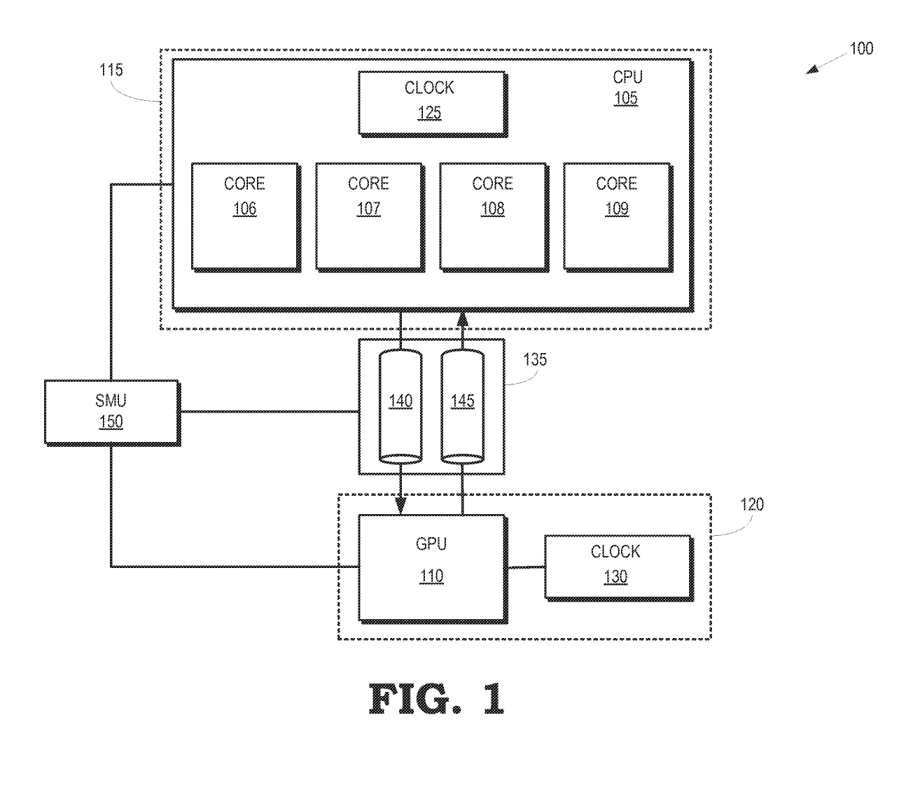

FIG. 1 is a block diagram of a processing device 100 according to some embodiments. The processing device 100 includes a central processing unit (CPU) 105 for executing instructions. Some embodiments of the CPU 105 include multiple processor cores 106, 107, 108, 109 (collectively referred to as “the processor cores 106-109”) that can independently execute instructions concurrently or in parallel. The CPU 105 shown in FIG.1 includes four processor cores 106-109. Persons of ordinary skill in the art having benefit of the present disclosure should appreciate that the number or size of processor cores in the CPU 105 is a matter of design choice. Some embodiments of the CPU 105 may include more or fewer than the four processor cores 106-109 shown in FIG.1

A graphics processing unit (GPU) 110 is also included in the processing device 100 for creating visual images intended for output to a display, e.g., by rendering the images on a display at a frequency determined by a rendering rate. Some embodiments of the GPU 110 may include multiple cores, a video frame buffer, or cache elements that are not shown in FIG.1 interest of clarity. The GPU 110 may render visual images using information provided by the CPU 105. For example, the CPU 105 may provide data used to render surfaces or objects and commands such as draw commands that indicate how the GPU 110 should render or “draw” the surfaces or objects. As discussed below, the data and commands may be provided in one or more packets.

The processing device 100 implements multiple timing domains 115, 120. As used herein, the term “timing domain” refers to a portion of the processing device 100 that uses a clock signal that is independent of one or more clock signals that are used by portions of the processing device 100 that are outside of the timing domain, e.g., portions of the processing device 100 that are in other timing domains. Some embodiments of the timing domains 115, 120 therefore include independent clocks 125, 130 that provide different clock signals to the circuitry in the timing domains 115, 120. The clock signals may be generated at different nominal clock frequencies. For example, the clock signal used within the timing domain 115 may be generated by a clock 125 that operates at a nominal frequency of 1 GHz and the clock 130 may provide a clock signal at a nominal frequency of 4 GHz to be used within the timing domain 120.

The operating frequencies of the clocks 125, 130 may differ from their nominal frequencies. For example, increasing the operating voltage of the clocks 125, 130 may increase their operating frequencies relative to their nominal frequencies and decreasing the operating voltages of the clocks 125, 130 may decrease their operating frequencies relative to their nominal frequencies. The frequencies of the clocks 125, 130 used in the timing domains 115, 120 may therefore be independently controlled or modified based on the operating voltages applied to the timing domains 115, 120. For example, the operating voltage in the timing domain 115 may be increased relative to the operating voltage used in the timing domain 120 to increase the operating frequency of the clock 125 relative to its nominal frequency or relative to the operating or nominal frequency of the clock 130.

Components in the different timing domains 115, 120 may communicate by exchanging signals or data via buffer circuitry 135. Some embodiments of the buffer circuitry 135 include queues 140, 145 for buffering data that is being conveyed between the timing domains 115, 120. For example, the buffer circuitry 135 may include a first-in-first-out (FIFO) queue 140 (or other type of queue) that receives data from the timing domain 115 that includes the CPU 105 and holds the data until it is requested by the timing domain 120, e.g., in response to a request from the GPU 110. In this example, the CPU 105 or one of the processor cores 106-109 may be referred to as the producing processor unit and the GPU 110 may be referred to as the consuming processor unit. For another example, the buffer circuitry 135 may include a FIFO queue 145 (or other type of queue) that receives data from the timing domain 120 and holds the data until it is requested by the timing domain 115, e.g., in response to a request from the CPU 105 or one of the processor cores 106-109. In this example, the GPU 110 may be referred to as the producing processor unit and the CPU 105 (or one of the processor cores 106-109) may be referred to as the consuming processor unit.

The processing device 100 may implement a system management unit (SMU) 150 that may be used for performance management or power management. Some embodiments of the SMU 150 may be implemented in software, firmware, or hardware and may be implemented outside of the timing domains 115, 120 as shown in FIG. 1. The SMU 150 can monitor the state of the buffer circuitry 135. For example, the SMU 150 may be able to monitor the size or occupancy of the FIFO queues 140, 145 by measuring the size continuously or at predetermined time intervals or time steps. Other information associated with the FIFO queue 140, 145 may also be available to the SMU 150. For example, the SMU 150 may have access to information indicating the complexity of the packets stored in the queues 140, 145 (e.g., as indicated by the number of calls to draw commands in the packet), the arrival rate at which packets are being added to the queues 140, 145, and the like.

Mismatches between the operating voltage, operating frequency, or nominal frequencies of the clock signals used in the timing domains 115, 120 may cause one or more of the FIFO queues 140, 145 to fill completely or empty out. In either case, the overall performance of the processing device 100 may be less than optimal. For example, when the queue 140 is frequently empty because the CPU 105 (or one of the processor cores 106-109) is not providing packets at a sufficiently high rate, the GPU 110 is not operated at maximum throughput. Conversely, if the CPU 105 (or one of the processor cores 106-109) is providing packets at too high a rate and the queue 140 fills up, the CPU 105 is unnecessarily using frequency (or equivalently, power) that the GPU 110 could have used to increase the overall throughput, e.g., in frames per second. The SMU 150 may therefore configure a first operating frequency of the CPU 105 (or one of the processor cores 106-109) and a second operating frequency of the GPU 110 based on a power constraint (e.g., a TDP or a limit on the power consumption set by a battery) of the processing device 100 and a target size of one or more of the queues 140, 145. The SMU 150 can select the first and second operating frequencies from a plurality of available operating frequencies for the CPU 105, one of the processor cores 106-109, or the GPU 110. The first and second operating frequencies may be selected so that an estimated power consumption of the processing device 100 is less than the power constraint.

Although two timing domains 115, 120 and the buffer circuitry 135 are shown in FIG. 1, some embodiments of the processing device 100 may include more than two timing domains that are interconnected by additional buffer circuitry that may include additional queues. Moreover, context switching may be implemented so that the queues 140, 145 may be used for different applications. The SMU 150 may be able to monitor fullnesses, rates of change of fullnesses, sizes of queues, predetermined time intervals, context identifiers, or times required to change the operating voltages or operating frequencies for the additional timing domains or buffer circuitry. The SMU 150 may also be able to concurrently predict underflow or overflow conditions in the additional queues and concurrently determine operating voltages or operating frequencies in one or more of the timing domains to avert or prevent the predicted underflow or overflow conditions. The number of timing domains and design of the buffer circuitry that interconnects the timing domains is a matter of design choice.

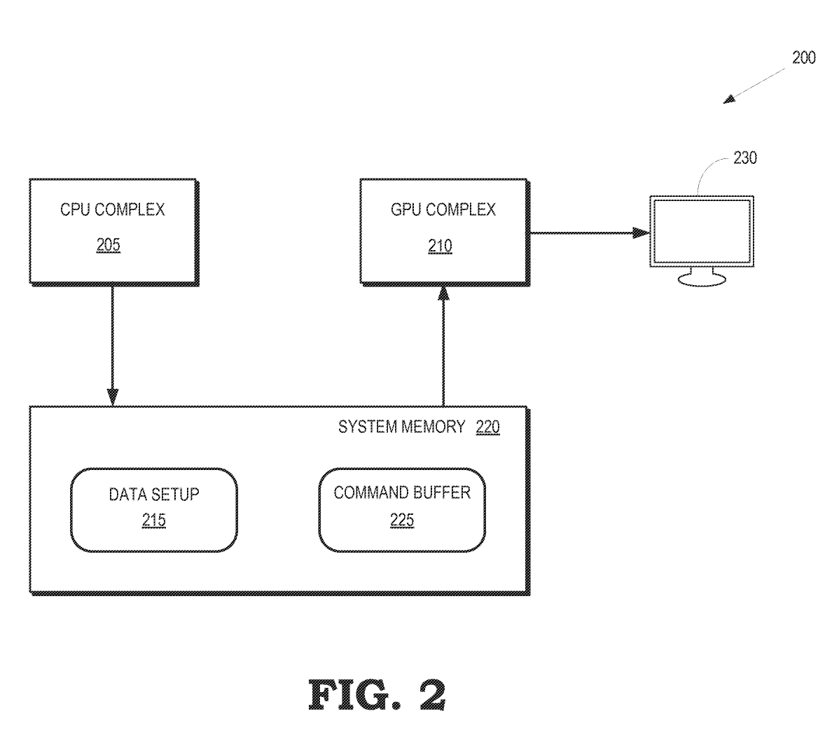

FIG. 2 is a block diagram of a processing device 200 according to some embodiments. The processing device 200 includes a CPU complex 205 that may include one or more CPUs, processor cores, or other logic. The processing device also includes a GPU complex 210 that may include one or more GPUs, processing cores, or other logic. The CPU complex 205 and the GPU complex 210 are configured to work together to perform applications that may be both computationally intensive and graphics intensive, perhaps at different times or in different phases of the application. For example, the CPU complex 205 may be used to run artificial intelligence portions of a game as well as providing data and commands for rendering video and audio. The GPU complex 210 may then be used to render the video and audio based on the data and commands provided by the CPU complex 205. For another example, the CPU complex 205 and the GPU complex 210 may exchange information to perform video transcoding or implement applications that use the Open Computing Language (CL) standards for parallel programming.

Some embodiments of the CPU complex 205 may therefore provide packets including data to a data set up queue 215 in a system memory 220 associated with the processing device 200. The CPU complex 205 may also provide packets including one or more commands to a command buffer 225, which may be implemented using one or more queues. Packets including the data or commands may then be provided to the GPU complex 210 from the data set up queue 215 or the command buffer 225, e.g., in response to a request from the GPU complex 210. The GPU complex 210 may process the data or commands and provide the rendered information for display by a display device 230. Some embodiments of the processing device 200 may also allow data or commands to flow in the opposite direction from the GPU complex 210, through the data set up queue 215 or the command buffer 225, and to the CPU complex 205. As discussed herein, the rate at which the CPU complex 205 provides packets and the time required for the GPU complex 210 to process a packet depend on their respective operating frequencies.

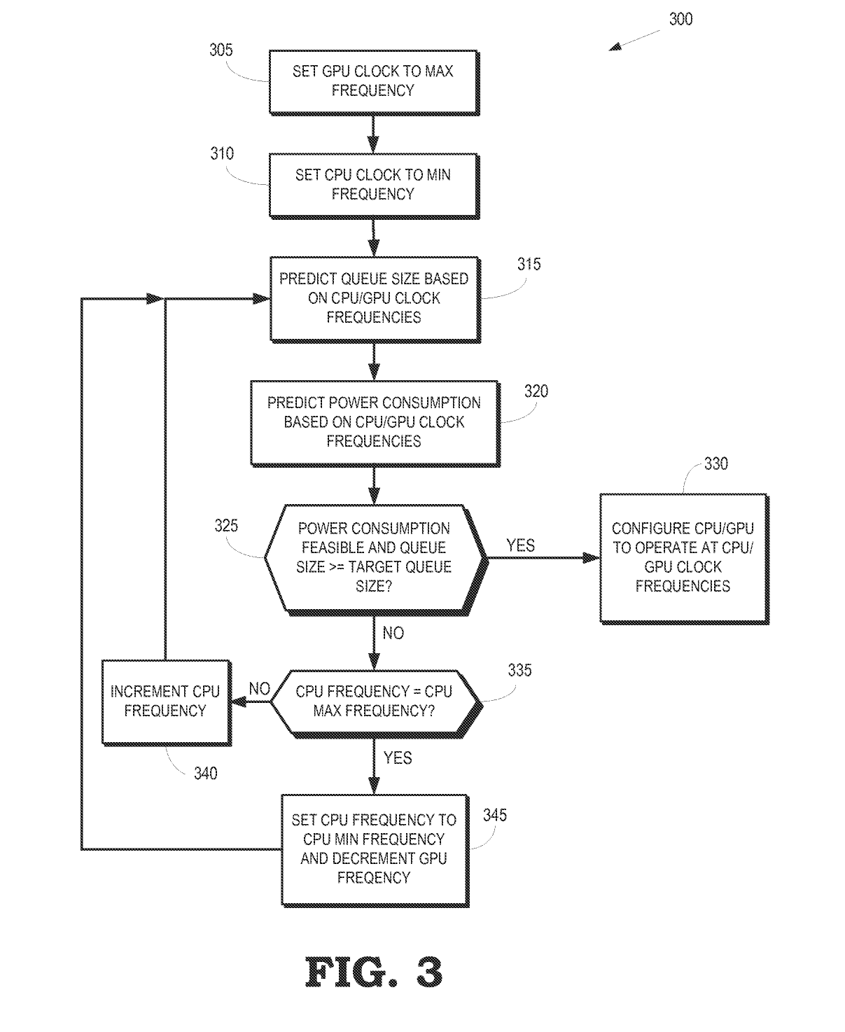

FIG. 3 is a flow diagram of a method 300 of configuring a CPU clock frequency and a GPU clock frequency according to some embodiments. The method 300 may be implemented in a controller such as the SMU 150 shown in FIG. 1. At block 305, the controller sets the GPU clock frequency to its maximum frequency, e.g., by applying a maximum voltage to the GPU. At block 310, the controller sets the CPU clock frequency to its minimum frequency, e.g., by applying a minimum voltage to the CPU. The GPU may therefore process packets from a queue in the shortest available amount of time and the CPU may be providing packets to the queue at the lowest available rate.

At block 315, the controller predicts a size of the queue based on the CPU clock frequency and the GPU clock frequency. For example, Little's Law predicts that the steady-state size (Q) of the queue can be defined as:

Q=A×T,

where A is the arrival rate of packets into the queue from the CPU and T is the time interval required for the GPU to process a packet from the queue. The arrival rate depends on the CPU clock frequency and the processing time interval depends on the inverse of the GPU clock frequency. For example, a linear scaling for the CPU clock frequency (Cclk) can be represented as:

A˜Cclk

A=K1×Cclk

where K1 is a workload-dependent proportionality constant that represents the sensitivity of the portion of the workload that executes on the CPU to the CPU clock frequency. The inverse scaling for the GPU clock frequency (Sclk) can be represented as:

$$T \sim \frac{1}{Sclk}$$

$$T = \frac{K 2}{Sclk}$$

where K2 is a workload-dependent proportionality constant that represents the sensitivity of the portion of the workload that executes on the GPU to the GPU clock frequency. The predicted steady-state queue size may therefore be represented as:

$$Q = K 1 \times K 2 \times \frac{Cclk}{Sclk}$$

Some embodiments of the controller may determine the proportionality constant K1 using online sampling. For example, for systems or applications that have relatively long application phases so that a large number of packets are transmitted between the CPU and the GPU via the queue, portions of the application may be executed on the CPU at different CPU clock frequencies and the rate of injection of packets into the queue can be measured. The measurements may then be modeled using a linear regression model to determine the proportionality constant K1. The number of measurements may be kept relatively small, e.g. less than 10, to reduce the complexity of the linear regression model. Some embodiments of the controller may determine the proportionality constant K1 using an off-line trained model that predicts the arrival rate (or a change in the arrival rate) as a function of the CPU clock frequency based on workload properties such as performance counters, instruction types, and the like.

Some embodiments of the controller may determine the proportionality constant K2 using online sampling. For example, for systems or applications that have relatively long phases so that a large number of packets are read from the queue by the GPU, the GPU may be run at different GPU clock frequencies and the time interval required to process packets from the queue can be measured. The measurements may then be modeled using a linear regression model to determine the proportionality constant K2. The number of measurements may be kept relatively small, e.g. less than 10, to reduce the complexity of the linear regression model. Some embodiments of the controller may determine the proportionality constant K2 using an off-line trained model that predicts the time interval required to process a packet as a function of the GPU clock frequency based on workload properties such as performance counters, instruction types, instruction complexity, and the like.

At block 320, the controller predicts power consumption by the processing device that includes the CPU and the GPU based on the CPU clock frequency and the GPU clock frequency. As discussed herein, the CPU and the GPU require higher voltages to operate at higher frequencies and consequently consume more power when they are operating at higher frequencies. The power consumption by the processing device may therefore be determined by combining the power consumed by the CPU, the GPU, and other logic on the processing device.

At decision block 325, the controller determines whether the power consumption is feasible and the predicted queue size is greater than or equal to the target queue size. For example, the controller may compare the predicted power consumption to a TDP for the processing device or other power constraint such as a power limit set by a battery in the processing device. If the power consumption is less than the limit set by the power constraint, the power consumption is considered feasible and, consequently, the CPU clock frequency and the GPU clock frequency are considered feasible. If the controller also determines that the predicted queue size is greater than or equal to the target queue size, the CPU and the GPU may be configured to operate at the CPU and GPU clock frequencies, respectively, at block 330. Some embodiments may implement other criteria such as requiring that the predicted queue size be within a selected tolerance of the target queue size. The method 300 may flow to decision block 335 if the power consumption is not feasible or the queue size is less than the target queue size.

At block 335, the controller determines whether the current CPU frequency is equal to the maximum CPU frequency. If not, the CPU frequency is incremented at block 340 and the method 300 performs another iteration beginning at block 315. If the current CPU has reached the maximum CPU frequency, the CPU frequency is set back to the minimum CPU frequency and the GPU frequency is decremented at block 345. The method 300 and performs another iteration beginning at block 315. The method 300 may continue until the CPU and GPU are configured at block 330. The method 300 may fail if every combination of the CPU clock frequency and the GPU clock frequency is tested and none of them provide a feasible level of power consumption and a queue size that is greater than the target queue size.

Some embodiments of the method 300 may use a binary search to identify the CPU clock frequency (instead of the iterative approach shown in FIG. 3) to reduce overhead. Some embodiments of the method 300 may also use factors for adjustment when there is a feedback dependence between CPU and GPU. In some embodiments, specialized target queue sizes may be selected for different categories of application by analyzing application properties.

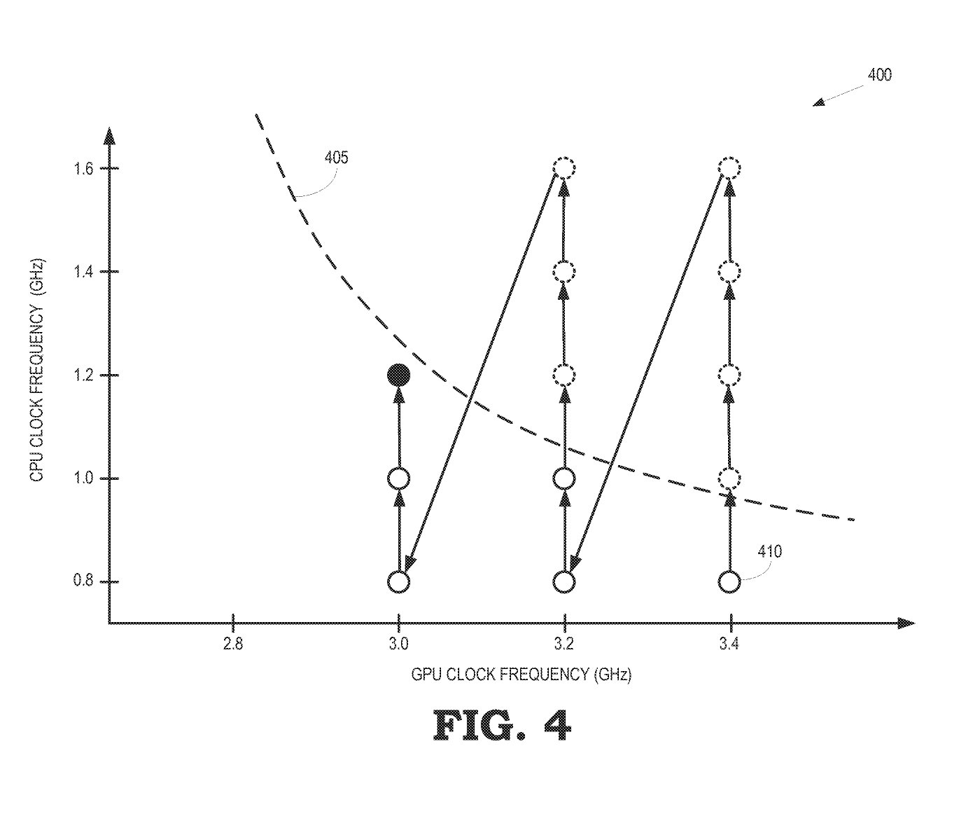

FIG. 4 is a plot 400 that depicts combinations of the CPU clock frequency and the GPU clock frequency according to some embodiments. The vertical axis indicates the CPU clock frequency in GHz and the horizontal axis indicates the GPU clock frequency in GHz. For example, the nominal CPU clock frequency may be 1.0 GHz and the operating CPU clock frequency may be varied in discrete steps from 0.8 GHz to 1.6 GHz by varying the operating voltage. The nominal GPU clock frequency may be 3.0 GHz and the operating GPU clock frequency may be varied in discrete steps from 2.8 GHz to 3.4 GHz. Some embodiments may allow different sized frequency steps or continuous variation in the operating frequencies. The dashed line 405 indicates the TDP limit for a processing device that includes the CPU and the GPU, although in other embodiments the dashed line 405 may indicate other power constraints or combinations of power constraints. Combinations of the CPU clock frequency and the GPU clock frequency that fall above the dashed line 405 violate the TDP limit and combinations that fall below the dashed line satisfy the constraints imposed by the TDP limit.

The plot 400 shows a sequence of combinations 410 (only one indicated by a reference numeral in the interest of clarity) of the CPU clock frequency and the GPU clock frequency. The combinations 410 may correspond to combinations that are evaluated according to embodiments of the method 300 shown in FIG. 3. For example, the initial combination (0.8, 3.4) may correspond to the minimum CPU frequency and maximum GPU frequency. This combination satisfies the power constraint represented by the dashed line 405 (as indicated by the solid line circle) but does not satisfy the requirement that the predicted queue size the less than or equal to the target queue size or within a selected tolerance of the target queue size. The CPU clock frequency is incremented (as indicated by the arrow) to the combination (1.0, 3.4), which increases the overall power consumption so that this combination does not satisfy the power constraint 405 (as indicated by the dashed line circle). The CPU clock frequency is then iteratively incremented through combinations at 3.4 GHz to the combination (1.6, 3.4).

No combination of CPU clock frequency with the GPU clock frequency of 3.4 GHz satisfies both the power constraint and the queue size requirements and so the CPU frequency is set to the minimum CPU frequency and the GPU frequency is decremented to the combination (0.8, 3.2). The CPU clock frequency is iteratively incremented through combinations at 3.2 GHz to the combination (1.6, 3.2). No combination of CPU clock frequency with the GPU clock frequency of 3.2 GHz satisfies both the power constraint and the queue size requirements and so the CPU frequency is set to the minimum CPU frequency and the GPU frequency is decremented to the combination (0.8, 3.0). The combinations (0.8, 3.0) and (1.0, 3.0) satisfy the power constraint requirement but not the queue size requirement. The combination (1.2, 3.0) satisfies both the power constraint requirement and the queue size requirement (as indicated by the filled circle). The CPU may therefore be configured to operate at 1.2 GHz and the GPU may be configured to operate at 3.0 GHz.

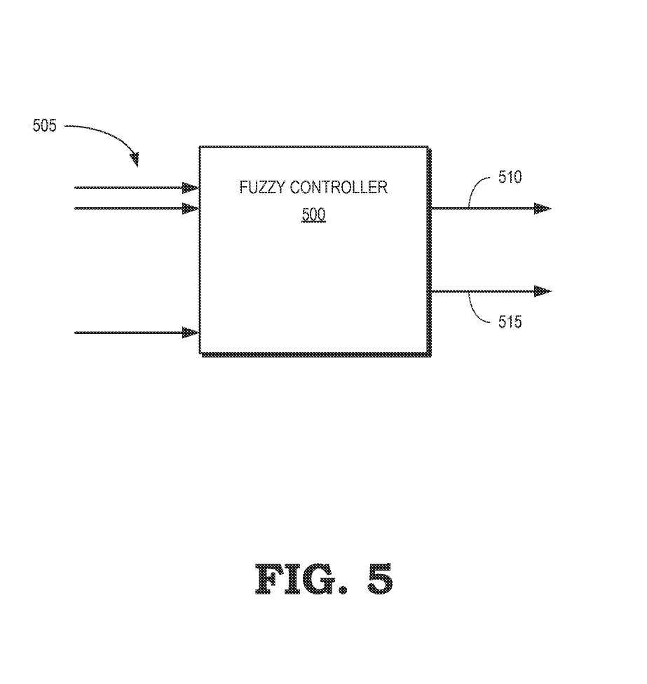

FIG. 5 is a block diagram of a fuzzy controller 500 according to some embodiments. Some embodiments of the fuzzy controller 500 may be implemented in a controller such as the SMU 150 shown in FIG. 1. The fuzzy controller 500 implements a multivariate or fuzzy control system that is used to model the set of equations that describe a size of a queue such as the queues 140, 145 shown in FIG. 1. Fuzzy control systems are known in the art and in the interest of clarity only those aspects of fuzzy control systems that are relevant to the claimed subject matter are discussed herein. Power constraints (such as the TDP constraint or battery power limits) on the CPU clock frequency (Cclk) and the GPU clock frequency (Sclk) may be expressed as a table of allowable equations or a polynomial equation since the power consumed by the CPU and the GPU varies cubically with their respective operating frequencies. For example, when the power constraint is established by the TDP, the total power (P) consumed by the processing device that includes the CPU and the GPU may be expressed as:

P=F(Cclk, Sclk)

P≦TDP,

where F is a cubic function.

The relationship between the total power P and the cubic function F may be determined based on input parameters 505. Examples of input parameters 505 include a packet arrival rate in the queue, a packet complexity, a current queue occupancy, and the like, although some embodiments may use more or fewer input parameters 505. The control variables 510, 515 represent values of the CPU clock frequency and the GPU clock frequency, respectively. The fuzzy controller 500 determines the CPU clock frequency and the GPU clock frequency using the control equations such that the size of the queue is maintained within a selected tolerance of a target queue size. Some embodiments may also add the constraint that the GPU clock frequency is maximized because there may be multiple fuzzy control points that satisfy the control equations.

In some embodiments, the apparatus and techniques described above are implemented in a system comprising one or more integrated circuit (IC) devices (also referred to as integrated circuit packages or microchips), such as the processing device described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

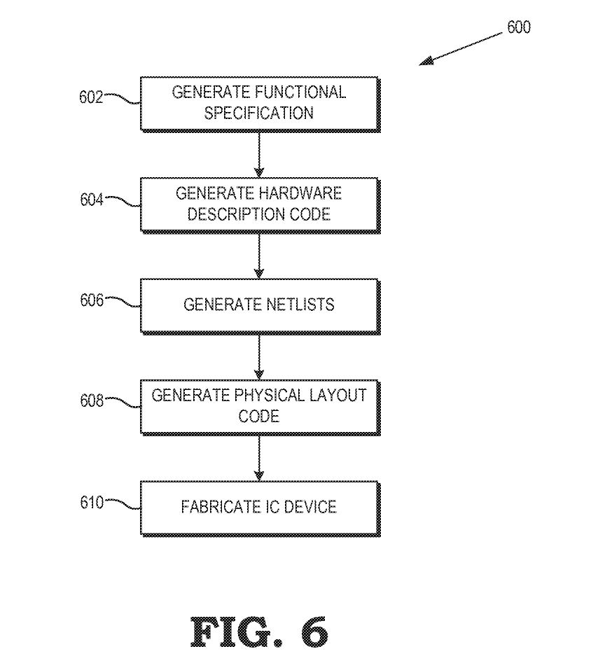

FIG. 6 is a flow diagram illustrating an example method 600 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
configuring a first operating frequency of a producing processor unit in a first timing domain of a processing device and a second operating frequency of a consuming processor unit in a second timing domain of the processing device that is asynchronous with the first timing domain based on a power constraint for the processing device and a target size of a queue that conveys data between the producing processor unit and the consuming processor unit.

2. The method of claim 1, further comprising:
selecting the first operating frequency from a plurality of available first operating frequencies and selecting the second operating frequency from a plurality of available second operating frequencies so that an estimated power consumption of the processing device is less than the power constraint for the processing device.

3. The method of claim 2, wherein selecting the first and second operating frequencies comprises selecting the first and second operating frequencies so that an estimated queue size is greater than the target size of the queue.

4. The method of claim 1, further comprising:
estimating the queue size by comparing a rate at which packets arrive in the queue from the producing processing unit and a time required for the consuming processing unit to process a packet from the queue.

5. The method of claim 4, further comprising:
determining a relationship between the rate at which packets arrive in the queue from the producing processing unit and the first operating frequency based on at least one of a rate for processing previous packets in the first processing unit and predicted properties of the packets; and
determining a relationship between the time required for the consuming processing unit to process a packet from the queue and the second operating frequency based on at least one of a time required to process a previous packet and a predicted property of the packet.

6. The method of claim 1, wherein configuring the first and second operating frequencies comprises dynamically controlling the first and second operating frequencies using fuzzy control logic.

7. The method of claim 6, wherein dynamically controlling the first and second operating frequencies comprises dynamically controlling the first and second operating frequencies based on monitored values of at least one of a packet arrival rate, a packet complexity, or a current queue occupancy.

8. An apparatus comprising:
at least one queue to convey data between a producing processor unit in a first timing domain of a processing device and a consuming processor unit in a second timing domain of the processing device that is asynchronous with the first timing domain; and
a system management unit to configure a first operating frequency of the producing processor unit and a second operating frequency of the consuming processor unit based on a power constraint for the processing device and a target size of the at least one queue.

9. The apparatus of claim 8, wherein the system management unit is to select the first operating frequency from a plurality of available first operating frequencies and select the second operating frequency from a plurality of available second operating frequencies so that an estimated power consumption of the processing device is less than the power constraint for the processing device.

10. The apparatus of claim 9, wherein the system management unit is to select the first and second operating frequencies so that an estimated queue size is greater than the target size of the queue.

11. The apparatus of claim 8, wherein the system management unit is to estimate the queue size by comparing a rate at which packets arrive in the queue from the producing processing unit and a time required for the consuming processing unit to process a packet from the queue.

12. The apparatus of claim 11, wherein the system management unit is to:
determine a relationship between the rate at which packets arrive in the queue from the producing processing unit and the first operating frequency based on at least one of a rate for processing previous packets in the first processing unit and predicted properties of the packets; and
determine a relationship between the time required for the consuming processing unit to process a packet from the queue and the second operating frequency based on at least one of a time required to process a previous packet and a predicted property of the packet.

13. The apparatus of claim 8, wherein the system management unit is to dynamically control the first and second operating frequencies using fuzzy control logic.

14. The apparatus of claim 13, wherein the system management unit is to dynamically control the first and second operating frequencies based on monitored values of at least one of a packet arrival rate, a packet complexity, or a current queue occupancy.

15. The apparatus of claim 8, wherein the producing processor unit is a central processing unit (CPU), and wherein the consuming processor unit is a graphics processing unit (GPU).

16. A non-transitory computer readable medium embodying a set of executable instructions, the set of executable instructions to manipulate at least one processor to:
configure a first operating frequency of a producing processor unit in a first timing domain of a processing device and a second operating frequency of a consuming processor unit in a second timing domain of the processing device that is asynchronous with the first timing domain based on a power constraint for the processing device and a target size of a queue that conveys data between the producing processor unit and the consuming processor unit.

17. The non-transitory computer readable medium of claim 16, wherein the set of executable instructions is to manipulate the at least one processor to:
select the first operating frequency from a plurality of available first operating frequencies and select the second operating frequency from a plurality of available second operating frequencies so that an estimated power consumption of the processing device is less than the power constraint for the processing device.

18. The non-transitory computer readable medium of claim 16, wherein the set of executable instructions is to manipulate the at least one processor to:
select the first and second operating frequencies so that an estimated queue size is greater than the target size of the queue, wherein the queue size is estimated by comparing a rate at which packets arrive in the queue from the producing processing unit and a time required for the consuming processing unit to process a packet from the queue.

19. The non-transitory computer readable medium of claim 16, wherein the set of executable instructions is to manipulate the at least one processor to:
determine a relationship between the rate at which packets arrive in the queue from the producing processing unit and the first operating frequency based on at least one of a rate for processing previous packets in the first processing unit and predicted properties of the packets; and
determine a relationship between the time required for the consuming processing unit to process a packet from the queue and the second operating frequency based on at least one of a time required to process a previous packet and a predicted property of the packet.

20. The non-transitory computer readable medium of claim 16, wherein the set of executable instructions is to manipulate the at least one processor to:
dynamically control the first and second operating frequencies using fuzzy control logic based on monitored values of at least one of a packet arrival rate, a packet complexity, or a current queue occupancy.
